(19) United States
(12) Patent Application Publication
(10) Pub. No.: US 2014/0064598 A1
(43) Pub. Date: Mar. 6, 2014

(54) MOBILE AND DESKTOP APPLICATION FOR EXTRACTING GEOMETRIC ELEMENTS AND MAPPING TO A MASTER KEY-CODE DATABASE

(71) Applicants: Adam P. Fagan, Rockville, MD (US); Gary A. Cohen, Baltimore, MD (US)

(72) Inventors: Adam P. Fagan, Rockville, MD (US); Gary A. Cohen, Baltimore, MD (US)

(21) Appl. No.: 13/868,997

(22) Filed: Apr. 23, 2013

Related U.S. Application Data
(63) Continuation-in-part of application No. 13/605,989, filed on Sep. 6, 2012.

(51) Int. Cl. G06T 7/00

(52) U.S. Cl. CPC G06T 7/0004
USPC 382/141

(57) ABSTRACT

A method and application provide a universal key code for use when a key is lost. The code can be taken to a locksmith or retailer for duplication. The user can obtain a digital image of their key and a software application can extract unique key geometries from the key, via, for example, edge detection technology and/or other mathematical methods, digital image processing methods and standard image processing methods. A key code can be determined from this extracted information and mapped to a known key code database. The software application can output, from a digital image of an original key, the key blank and key cut code to allow a consumer to simply and conveniently obtain a duplicate key.

### CROSS-REFERENCE TO RELATED APPLICATIONS

This application is a continuation in part of U.S. patent application Ser. No. 13/605,989, filed Sep. 6, 2012, currently pending.

### BACKGROUND OF THE INVENTION

The present invention relates to a key code system and, more particularly, to a mobile or desktop application using mathematical methods, digital image processing and standard image processing to extract critical geometric elements and map to a master key-code database.

Currently, an original key is necessary to make a copy of the key. If the original is lost, no copy can be made unless the key code is available or by using a locksmith.

Keys are able to be cut from a key-code. For each manufacturer of a keyed system, a specific key blank can fit into the key cylinder. The specific cuts can be measured and recorded into a database. Each entry in this database can have a specific key code assigned thereto. Most consumers, however, do not know the key code assigned to their key. There is currently no way for a user to obtain such a key code for future duplication from the key itself.

As can be seen, there is a need for a method and application for extracting geometric elements from a key and mapping these elements to a master key-code database, allowing a consumer to obtain a copy of a key without having the original.

### SUMMARY OF THE INVENTION

In one aspect of the present invention, a method for making a duplicate key comprises taking a digital image or digital scan of an original key; extracting geometric information from the original key via a computing device; matching the geometric information to a key code in a key code database; and providing the key code to a user on their computing device.

In another aspect of the present invention, a computer-implemented method, written as a programmable code, stored on a computer readable medium, and adapted to generate a key code for a user's key comprises the steps of obtaining a digital image or scan of an original key; processing the digital image or scan to extract geometric information about the original key; matching the geometric information to a key code database; and providing the key code to the user, the key code permitting duplication of the original key without requiring the original key.

These and other features, aspects and advantages of the present invention will become better understood with reference to the following drawings, description and claims.

### BRIEF DESCRIPTION OF THE DRAWINGS

FIG. 1 is a schematic view showing a method for obtaining a duplicate key according to an exemplary embodiment of the present invention;

FIG. 2 is an enlarged view of a key for which the method and application of the present invention can determine a key-code therefore; and

FIG. 3 is an enlarged detail view of a key, showing exemplary measurements determined by the application and method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides methods and applications for providing a universal key code for use when a key is lost. The code can be taken to a locksmith or retailer for duplication. The user can obtain a digital image of a key either by camera or scanner and a software application can extract unique key geometries from the key, via, for example, edge detection technology and/or other mathematical methods, digital image processing methods and standard image processing methods. A key code can be determined from this extracted information and mapped to a known key code database. The software application can output, from a digital image of an original key, the key blank and key cut code to allow a consumer to simply and conveniently obtain a duplicate key.

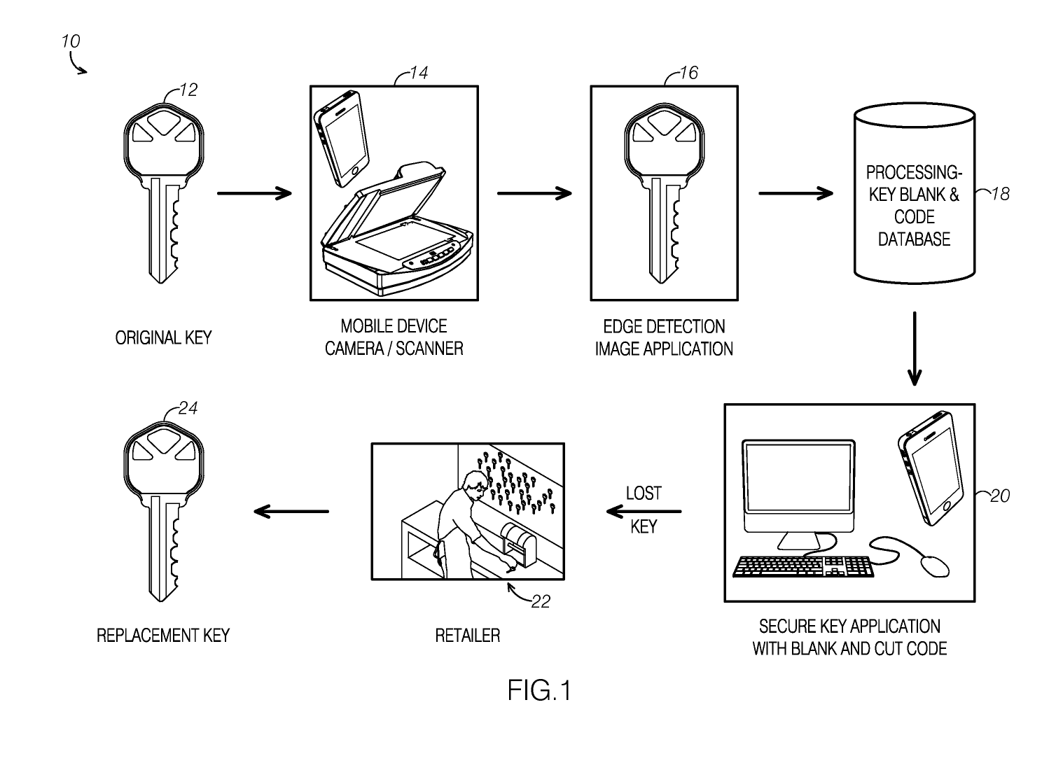

Referring now to FIG. 1, a method 10 is shown for obtaining a replacement key 24 from a digital image 16 of an original key 12. A mobile device 14, such as a smartphone with a camera, or a digital scanner or digital camera, can capture the image 16 of the original key 12. Software can include algorithms to extract geometric features of the key. The algorithm can take the extracted geometric features and compare such features to a key blank and key code database. The algorithms can include histogram analysis to determine the background color and compute the vector of that color, a vector keying algorithm to remove the background and generate a binary (black and white) mask that outlines the objects in the image, and other methods, such as contour maps, thresholding, edge-detection and perhaps other similar technologies. The software can reside on a computing device 18 that receives the image taken by the smartphone, digital camera or digital scanner, processes the image as described above, and outputs a key blank and cut code that is delivered back to the end users mobile device or compute desktop. In some embodiments, the computing device 18 can be a centralized server, providing software processing of key images of multiple users. In some embodiments, the software can reside on a personal computing device of the user, such as the user's smartphone.

Thus, the mobile and desktop application can provide the user with key blank and cuts codes, as shown in step 20. If the user loses their key, they can simply provide a retailer or locksmith 22 their blank and key code information and a replacement key 24 can be prepared. The mobile application can retain information about each of the user's keys. The application can include methods for labeling each key blank and code information with key identification information. For example, if a user loses their shed lock door key, they can look on their mobile application or desktop computer and open the file related to the shed lock door to find their blank is a M1 master lock blank and their key code is 12345. The retailer or locksmith can use this information to easily and quickly provide a duplicate key.

In some embodiments, the key code created by the software may, instead of being provided to the user, be stored in a secure account established for the user. The account may be a store loyalty account, for example, where a member can sign into their account and have the store prepare a spare key for them that can be ready when they arrive at the store.

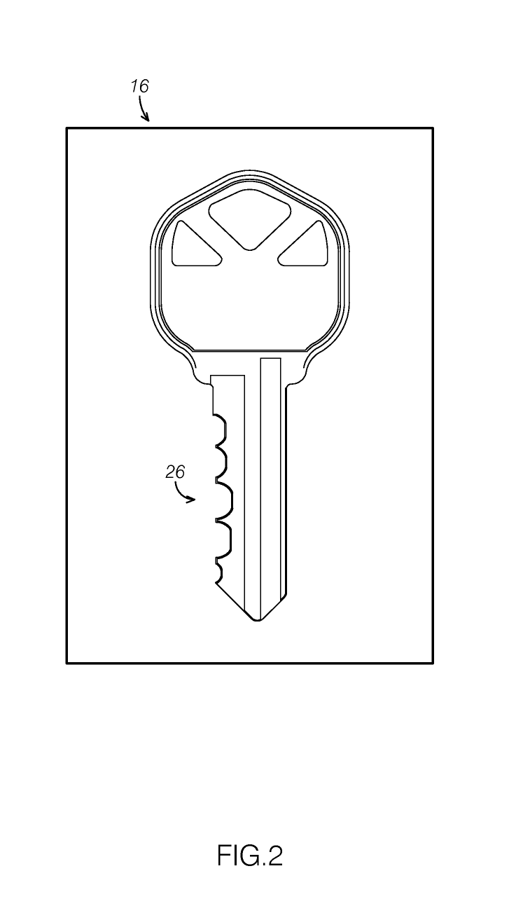

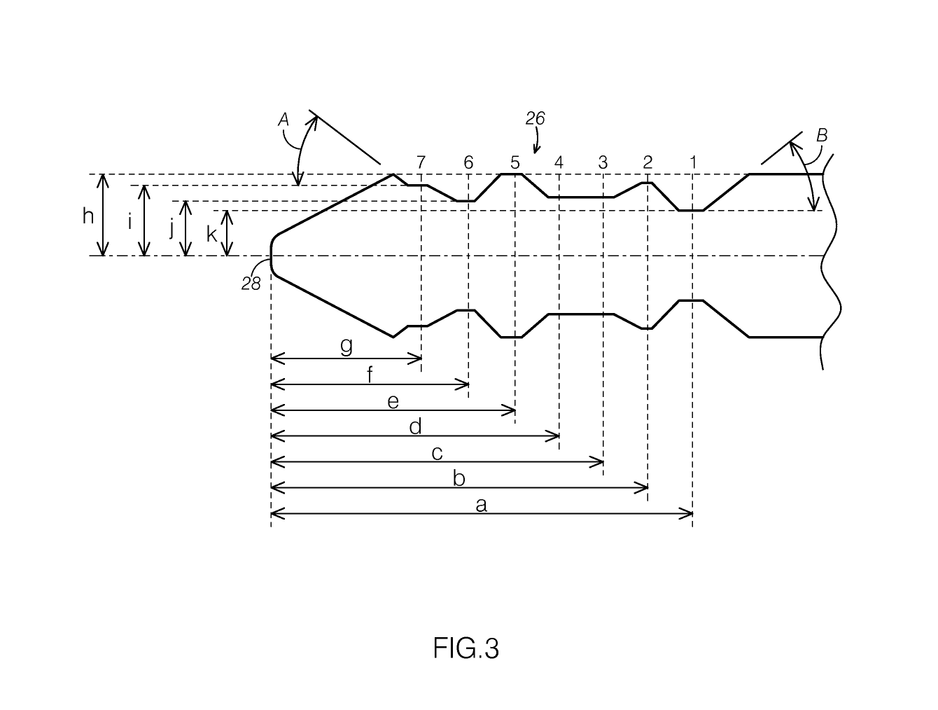

Referring to FIGS. 2 and 3, the picture 16 of the key, from which mathematical methods, digital image processing methods and standard image processing methods can obtain key geometries, can include a side view of the blade 26 of the key 12. As shown in detail in FIG. 3, the application of the present invention can measure various angles, A, B, and also measure various longitudinal dimensions a-g associated with spaces 1-7 of the blade 26 as well as transverse dimensions h-k associated with depths of cut on the blade 26. While FIG. 3 shows exemplary geometries extracted by the software of the present invention, other measurements may be used, depending on the type of key, for example.

The above refers to using mathematical methods, digital image processing methods and standard image processing methods for processing the picture to obtain key geometries. These methods can include edge detection technology, Histogram Analysis, Vector Keying, Contour Maps, Thresholding, and the like, to determine the necessary geometric information.

While the above refers to a mobile and desktop application that determines a key blank and key code from a digital image taken with a mobile electronic device, a digital camera or digital scanner, the methods and software of the present invention could be applied to different electronic and computing devices. For example, any digital device could be used to obtain an image and a desktop computer, laptop computer or tablet computer could be used to process the uploaded digital image and determine the geometric information of the key.

It should be understood, of course, that the foregoing relates to exemplary embodiments of the invention and that modifications may be made without departing from the spirit and scope of the invention as set forth in the following claims.

What is claimed is:

1. A method for making a duplicate key comprising:
obtaining a digital image of an original key;
extracting geometric information from the digital image via a computing device; and
matching the geometric information to a key code in a key code database.

2. The method of claim 1, further comprising providing the key code to a user.

3. The method of claim 1, further comprising storing the key code in a secure account assigned to a user.

4. The method of claim 1, further comprising determining a key blank of the original key.

5. The method of claim 4, further comprising cutting the key blank with the appropriate cuts based on the key code.

6. The method of claim 2, wherein the key code is provided to the user on a user personal computing device.

7. The method of claim 1, wherein mathematical methods, digital image processing technology and standard image processing technology is used to extract the geometric information.

8. The method of claim 1, further comprising adding a new key code to the key code database when the geometric information cannot be matched to an existing key code.

9. A computer-implemented method, written as a programmable code, stored on a computer readable medium, and adapted to generate a key code for a user's key, the method comprising:
obtaining a digital image of an original key;
processing the digital image to extract geometric information about the original key; and
matching the geometric information to a key code database.

10. The computer-implemented method of claim 9, further comprising providing the key code to the user, the key code permitting duplication of the original key without requiring the original key.

11. The method of claim 9, wherein mathematical methods, digital image processing technology and standard image processing technology is used to process the digital image.

12. The method of claim 9, wherein the computer-implemented method is configured to operate on a computing device and the digital image is obtained by a mobile device, digital camera or digital scanner.

13. The method of claim 9, further comprising adding a new key code to the key code database when the geometric information cannot be matched to an existing key code.
